(19) United States
(12) Patent Application Publication
(10) Pub. No.: US 2005/0289592 A1
(43) Pub. Date: Dec. 29, 2005

(54) System and method for service listings

(76) Inventor: Larri Vermola, Turku (FI)

Correspondence Address: MORGAN & FINNEGANN, L.L.P., 345 Park Avenue, New York, NY, 10154-0053, US

(21) Appl. No.: 10/880,102

(22) Filed: Jun. 29, 2004

(51) Int. Cl. G06F 13/00; H04N 7/025

(52) U.S. Cl. 725/45; 725/46; 725/34

(57) ABSTRACT

Systems and methods applicable, for example, in the provision of service listings, channel listings, and/or the like. A device may, for example, detect one or more datacast signals, receive one or more service parameters corresponding to detected signals, and/or offer one or more available service listings, channel listings, and/or the like to its user.

### FIELD OF INVENTION

This invention relates to systems and methods for service listings.

### BACKGROUND INFORMATION

In recent years, there has been an increase in receivable programming.

For instance, a wide variety of programs (e.g., video programs, audio programs, and interactive programs) may be received via, for example, Amplitude Modulation (AM) radio, Frequency Modulation (FM) radio, Digital Audio Broadcast (DAB), Digital Radio Mondial (DRM), Digital Video Broadcast (DVB), satellite radio, satellite television, National Television System Committee (NTSC) television, Phase Alternating Line (PAL) television, and the Internet.

Accordingly, there may be interest in technologies that facilitate the use of such programs.

### SUMMARY OF THE INVENTION

According to various embodiments of the present invention there are provided systems and methods applicable, for example, in the provision of service listings, channel listings, and/or the like.

A device may, in various embodiments, detect one or more datacast signals, receive one or more service parameters corresponding to detected signals, and/or offer one or more available service listings, channel listings, and/or the like to its user.

### BRIEF DESCRIPTION OF THE DRAWINGS

FIG. 1 shows exemplary steps involved in datacast signal and service parameter operations, and offering of service listings, channel listings, and/or the like according to various embodiments of the present invention.

FIG. 2 shows an exemplary interface according to various embodiments of the present invention.

FIG. 3 shows exemplary steps involved in service listings data, channel listings data, and/or the like operations according to various embodiments of the present invention.

FIG. 4 shows exemplary steps involved in provision of service listings, channel listings, and/or the like according to various embodiments of the present invention.

FIG. 5 shows an exemplary computer.

FIG. 6 shows a further exemplary computer.

### DETAILED DESCRIPTION OF THE INVENTION

General Operation

According to various embodiments of the present invention there are provided systems and methods applicable, for example, in the provision of service listings, channel listings, and/or the like.

A device (e.g., a wired or wireless node and/or other computer, a television receiver, a radio receiver, and/or the like) may, in various embodiments, detect one or more datacast signals, and may receive one or more service parameters corresponding to the detected signals.

Moreover, in various embodiments the device may, perhaps via the use of one or more of the received service parameters; offer one or more available service listings, channel listings, and/or the like to its user. Accordingly, for instance, a Graphical User Interface (GUI), other interface, and/or the like allowing for selection of the one or more available service listings, channel listings, electronic program guide (EPG), electronic service guide (ESG), interactive service guide (ISG), and/or the like might be presented to the user.

The device may, in various embodiments, employ appropriate received service parameters in receiving service listings data, channel listings data, and/or the like corresponding to service listings, channel listings, and/or the like selected by the user. Moreover, the device may, in various embodiments, employ some or all of the received service listings data, channel listings data, and/or the like in presenting (e.g., via a GUI, other interface, and/or the like) one or more of the selected service listings, channel listings, and/or the like to the user.

Various aspects of the present invention will now be discussed in greater detail:

Datacast Signal and Service Parameter Operations

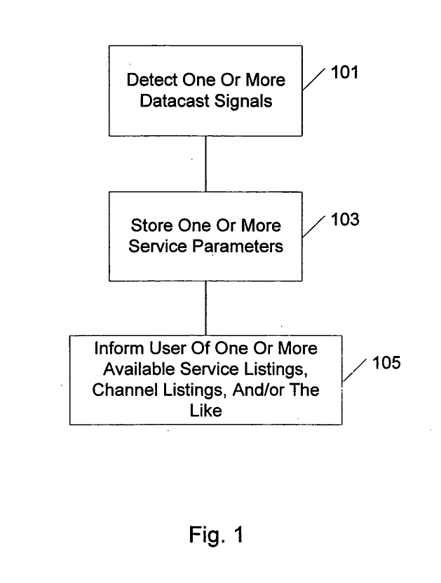

With respect to FIG. 1 it is noted that according to various embodiments of the present invention a device (e.g., a wired or wireless node and/or other computer, a television receiver, a radio receiver, and/or the like) may act to detect one or more datacast signals (e.g., Internet Protocol Datacast (IPDC) signals) (step 101). Moreover, in various embodiments, a device may act to receive one or more service parameters corresponding, for instance, to such detected signals. For example, a device may act to receive, with respect to each of one or more of the detected signals, one or more service parameters.

Various data could, in various embodiments, be included in service parameters. For instance, included could be, perhaps for one or more service areas, available service information, channel information, and/or the like (perhaps corresponding to one or more subscriptions, packages, and/or the like), service area information (e.g., geographical coverage area information, service area identifiers, and/or the like), service provider descriptions (e.g., service provider names, identifiers such as widgets or icons, and/or the like), frequencies, network addresses, and/or the like for receipt service listings data, channel listings data, and/or the like, network parameters (e.g., network identifiers, network names, Network Information Table (NIT) versions, signal lists, platform lists, network addresses (e.g., an IP address), multicast addresses (e.g., an IP multicast address) and/or the like), platform parameters (e.g., platform identifiers, platform names, and/or the like), routing table parameters (e.g., routing table lists, identifiers, and/or the like), signal parameters, cell identifiers, tuning parameters, transport stream identifiers, identifiers for subscriptions, packages, and/or the like, and/or the like.

Receipt of service parameters may, in various embodiments, involve Internet Protocol Datacast (IPDC) (e.g., receipt of an IPDC data stream), Universal Mobile Telecommunications Service (UMTS), General Packet Radio Service (GPRS), Short Message Service (SMS), Multimedia Messaging Service (MMS), email, Simple Object Access Protocol (SOAP), Java Messaging Service (JMS), Remote Method Invocation (RMI), Multimedia Broadcast and Multicast Service (MBMS), Digital Video Broadcast (DVB) (e.g., terrestrial digital video broadcast (DVB-T), Digital Video Broadcasting: Handhelds (DVB-H), Satellite Digital Video Broadcast (DVB-S), and/or the like), Digital Audio Broadcast (DAB), Digital Radio Mondial (DRM), Internet Protocol (IP), Amplitude Modulation (AM) radio, Frequency Modulation (FM) radio (e.g., via FM subcarrier), Radio Data System (RDS), satellite radio, television, digital television, satellite television, National Television System Committee (NTSC) television, Phase Alternating Line (PAL) television, and/or the like (e.g., via blanking interval and/or the like), and/or the like.

In various embodiments, one or more service parameters may be received via receipt of one or more NITs and/or the like. In various embodiments, in receipt of service parameters, a device tuner might be set to a particular frequency, and/or the device might associate itself with a multicast address (e.g., an IP multicast address), the device might access data from a particular network address (e.g., an IP address), and/or the like. It is noted that, in various embodiments, one or more received service parameters may be stored. It is further noted that, in various embodiments, one or more received NITs may be stored.

In acting to detect one or more datacast signals and/or receive one or more service parameters, the device might, for example, act to scan signals in one or more frequency ranges, perhaps taking into account one or more bandwidths. Such frequency ranges and/or bandwidths might, for instance, be set by a user, a system administrator, a manufacturer, a service provider, and/or the like. For example, in various embodiments scanning might be with respect to a frequency range of 474-858 MHz and a bandwidth of 8 MHz. It is noted that, in various embodiments, scanning may involve the interpretation of one or more NITs.

In various embodiments, in scanning for datacast signals the device may act to tune to one or more of the frequencies relating to a particular frequency range and corresponding bandwidth. For instance, where the frequency range was x-y MHz and the corresponding bandwidth was z MHz, the node might act to tune to one or more of the frequencies x+a·z, with the value of a ranging, by increments of one, from 0 to

$$\frac{y - x}{z} .$$

In various embodiments, in acting to tune to a particular frequency, in the case where the device is unable to achieve tuning lock the device may act to skip to the next frequency in the sequence.

Tuning to a particular frequency in the sequence, the device might, for example, act to create a NIT program identifier (PID) filter and/or the like, and/or to check NIT network identifier and/or the like In various embodiments, in the case where the device determines that that the NIT network identifier check has already been performed, the device may act to skip to the next frequency in the sequence.

As a next step, perhaps after determining that the NIT network identifier check has not already been performed, the device may act to check for NIT linkage descriptor (e.g., 0×0B) presence and/or the like. In various embodiments, in the case where the linkage descriptor and/or the like is not found, the device may act to skip to the next frequency in the sequence.

In the case where the linkage descriptor and/or the like is found, the device might, in various embodiments, act to, perhaps via NIT parsing and/or the like, store one or more service parameters (e.g., for each NIT-listed signal and/or the like) (step 103). In various embodiments only service parameters associated with one or more specified platform identifiers (e.g., linkage descriptor-listed platform identifiers) might be stored. Such platform identifiers might, for instance, be specified by a user, a system administrator, a manufacturer, a service provider, and/or the like.

In various embodiments, among stored service parameters may, for example, be one or more cell identifiers, network identifiers (e.g., original network identifiers, time-slice network identifiers, and/or the like), transport stream identifiers, tuning parameters, network names, widgets or icons describing networks or service providers, NIT versions, signal lists, platform lists, platform identifiers, platform names, routing table lists, signal lists, signal parameters, IP/Media Access Control (MAC) notification table program map table service identifiers, hierarchy information, hierarchy priorities, center frequencies, bandwidths, constellations, code rates, guard intervals, transmission modes, use information, frame size information, max burst duration information, and/or the like.

Offering of Service Listings, Channel Listings, and/or the Like

With further respect to FIG. 1 it is noted that, according to various embodiments of the present invention, the device may, perhaps via a GUI, other interface, and/or the like act to inform its user of one or more available service listings, channel listings, service providers and/or the like, to allow its user to select one or more available service listings, channel listings, service provider listings and/or the like, and/or the like (step 105). Such functionality may be implemented in a number of ways.

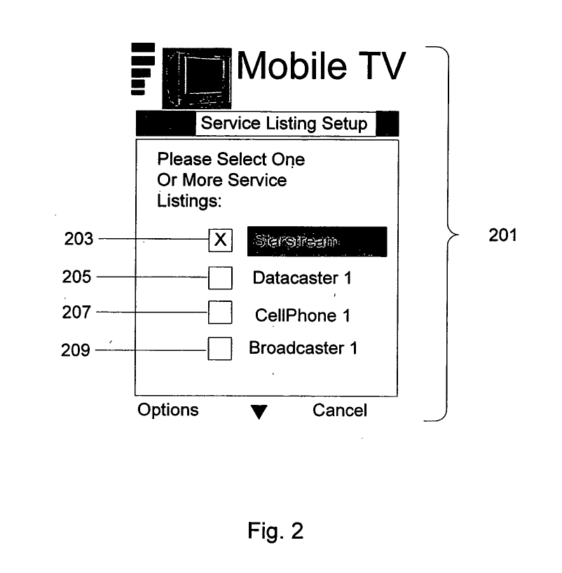

With respect to the exemplary interface of FIG. 2 it is noted that, in various embodiments a GUI, other interface, and/or the like (201) may be employed to present one or more, perhaps selectable, elements, widgets, icons, and/or the like (203-209) to the user. Each element, widget, icon, and/or the like might, for example, covey (e.g., via text, graphics, icons, and/or the like) an available service listing, channel listing, and/or the like. In various embodiments, text, graphics, icons, and/or the like might, alternately or additionally, be employed to convey one or more service providers, service provider names, and/or the like. In various embodiments, via, for instance, the user interacting with the GUI, other interface, and/or the like, the device could come to know service listings, channel listings, and/or the like desired by the user.

Accordingly, for instance, a number of GUI checkboxes with associated appropriate text, graphics, icons, and/or the like, corresponding to available service listings, channel listings, service providers, and/or the like might be presented to the user, and the user could employ the checkboxes to indicate her selections.

It is noted that, in various embodiments, one or more received service parameters may be employed. For instance, in various embodiments, one or more platforms names, platform identifiers, and/or the like may be employed in implementing one or more of the elements, widgets, icons, and/or the like (e.g., appropriate corresponding platform names, platform identifiers, and/or the like might be linked).

Service Listings Data, Channel Listings Data, and/or the Like Operations

According to various embodiments, the device may act to employ appropriate received service parameters in receiving, storing, presenting and/or the like service listings data, channel listings data, and/or the like corresponding to service listings, channel listings, and/or the like selected by the user. Such functionality may be implemented in a number of ways.

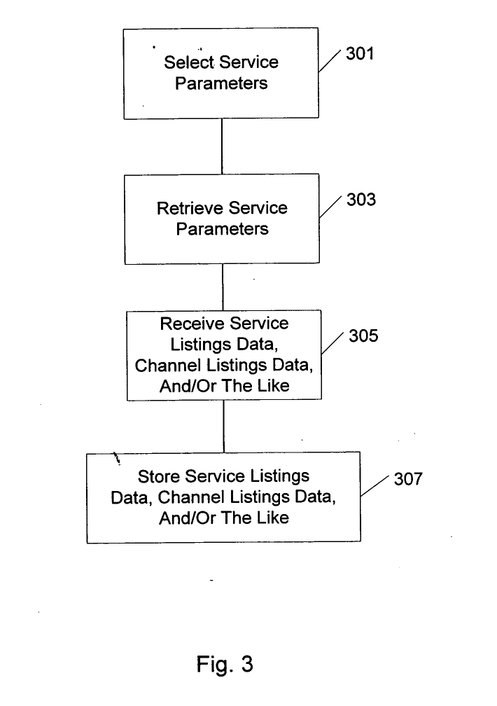

With respect to FIG. 3 it is noted that, for instance, the device might, in various embodiments, act to select from accessible service parameters (e.g., service parameters held in an accessible store) appropriate service parameters corresponding to the service listings, channel listings, service provider listings and/or the like selected by the user (step 301). The accessible service parameters might, in various embodiments, be associated (e.g., via lookup tables, stores, and/or the like) with available service listings, channel listings, and/or the like, and the device might employ such associations in selection.

Having performed service parameter selection the device could, in various embodiments, retrieve, access, and/or the like the selected service parameters (step 303). Service parameters employable in the receipt service listings data, channel listings data, and/or the like could include, for instance, frequencies, network addresses, and/or the like, information regarding one or more subscriptions, packages, and/or the like (e.g., of the device's user), and/or the like.

Receipt, using appropriate service parameters, of the service listings data, channel listings data, and/or the like corresponding to service listings, channel listings, and/or the like selected by the user (step 305) could, in various embodiments, involve IPDC, UMTS, GPRS, SMS, MMS, email, SOAP, JMS, RMI, MBMS, DVB (e.g., DVB-T, DVB-H, DVB-S, and/or the like), DAB, DRM, IP, AM radio, FM radio (e.g., via FM subcarrier), RDS, satellite radio, television, satellite television, NTSC television, PAL television, and/or the like (e.g., via blanking interval and/or the like), and/or the like. For instance, an IPDC data stream might be received, a device tuner might be set to a particular frequency, the device might access data from a particular network address (e.g., an IP address), the device might associate itself with a multicast address (e.g., an IP multicast address), and/or the like. Some or all of the received service listings data, channel listings data, and/or he like may, in various embodiments, be stored by the device (step 307).

It is noted that, in various embodiments, at least some of employed service parameters, and/or received service listings data, channel listings data, and/or the like may be related to one or more platform identifiers. It is further noted that, in various embodiments, there may be one or more service providers using multiple frequencies to make available service listings data, channel listings data, and/or the like corresponding to one or more service listings, channel listings, and/or the like.

Provision of Service Listings, Channel Listings, and/or the Like

According to various embodiments of the present invention, some or all of the received service listings data, channel listings data, and/or the like may be employed in presenting to the user one or more of the selected service listings, channel listings, and/or the like. Such functionality may be implemented in a number of ways.

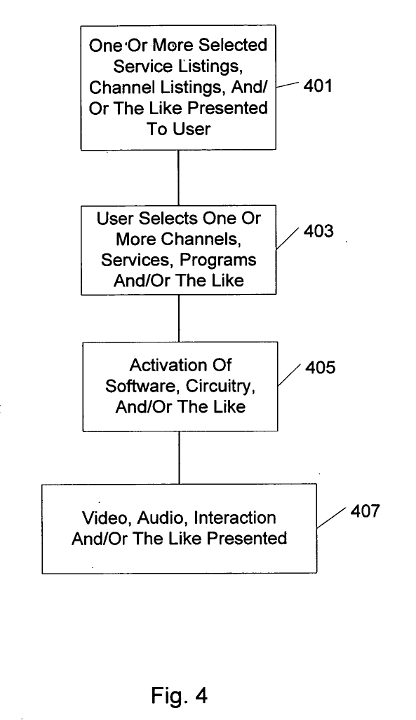

With respect to FIG. 4 it is noted that, for example, the user may be presented with one or more of the selected service listings, channel listings, service providers listings and/or the like in the form of one or more GUIs, grids, and/or other interfaces displaying information about one or more available programs and/or the like (e.g., video, audio, and/or interactive programs), perhaps with respect to one or more particular time periods (step 401). Such a time period might, for example, be specified by the user, correlate to a current time, and/or the like. In various embodiments, indication of one or more available services, channels, and/or the like might be provided via the GUIs, grids, and/or other interfaces, with indication of one or more available programs and/or the like being presented for each service, channel, and/or the like.

It is noted that, in various embodiments, the GUIs, grids, and/or other interfaces might act to display only channels, services, programs, and/or the like available in accordance, with one or more subscriptions, packages, and/or the like of the user. It is further noted that the user may, in various embodiments, be able to search among available channels, services, programs, and/or the like, be able to select one or more channels, services, programs, and/or the like for receipt, recording, use, and/or the like, and/or the like (step 403).

Accordingly, for instance, selection (e.g., via a provided GUI, grid, and/or other interface) of a particular program and/or the like indicated as available by a service listing, channel listing, and/or the like may result in the activation of software, circuitry, and/or the like (step 405) whereby, for example, video, audio, data, interaction, and/or the like may be presented (step 407).

Receipt, recording, use, and/or the like of a program and/or the like may, in various embodiments, involve IPDC, UMTS, GPRS, SMS, MMS, email, SOAP, JMS, RMI, MBMS, DVB (e.g., DVB-T, DVB-H, DVB-S, and/or the like), DAB, DRM, IP, AM radio, FM radio, satellite radio, satellite television, NTSC television, PAL television, and/or the like.

It is noted that, in various embodiments, service listings, channel listings, and/or the like may be able to support various hierarchies (e.g., service hierarchies, session hierarchies, and/or the like).

Hardware and Software

Various operations and/or the like described herein may be executed by and/or with the help of computers. Further, for example, devices described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, a mobile communication device, phone, node, and/or the like, a server, a network access point, a network multicast point, a set-top box, a personal video recorder (PVR), a radio (e.g., a digital radio), a television (e.g., a digital television), portable television, a game console, or the like, perhaps running an operating system such as OS X, Linux, Darwin, Windows CE, Windows XP, Windows Server 2003, Palm OS, Symbian OS, or the like, perhaps employing the Series 40 Platform, Series 60 Platform, and/or Series 90 Platform, and perhaps having support for Java and/or .Net.

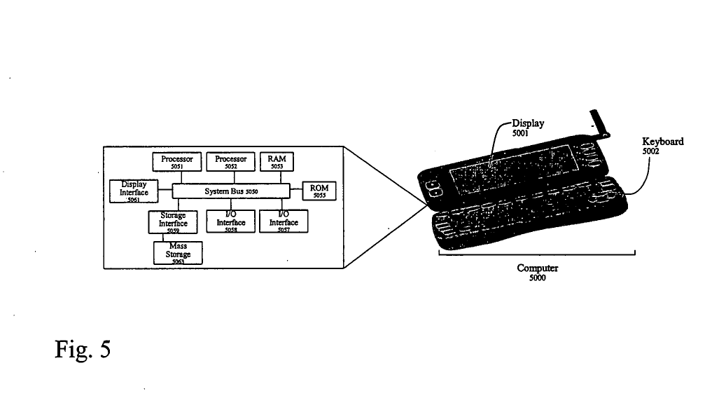

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, exemplary computer 5000 as shown in FIG. 5 includes system bus 5050 which operatively connects two processors 5051 and 5052, random access memory 5053, read-only memory 5055, input output (I/O) interfaces 5057 and 5058, storage interface 5059, and display interface 5061. Storage interface 5059 in turn connects to mass storage 5063. Each of I/O interfaces 5057 and 5058 may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16x, IEEE 802.20, IEEE 802.15.3, ZigBee, Bluetooth, wireless universal serial bus (WUSB), wireless Firewire, terrestrial digital video broadcast (DVB-T), satellite digital video broadcast (DVB-S), DVB-H (Digital Video Broadcasting: Handhelds, Digital Audio Broadcast (DAB), satellite radio, Digital Radio Mondial (DRM), Digital Audio Broadcasting (DAB), amplitude modulation (AM) radio, frequency modulation (FM) radio, television, satellite television, digital cable television, Phase Alternating Line (PAL) television, National Television Standards Committee (NTSC) television, wireless telecommunication network, General Packet Radio Service (GPRS), Universal Mobile Telecommunications Service (UMTS), Global System for Mobile Communications (GSM), IrDA (Infrared Data Association), and/or other interface.

Mass storage 5063 may be a hard drive, optical drive, or the like. Processors 5051 and 5052 may each be a commonly known processor such as an IBM or Motorola PowerPC, an AMD Athlon, an AMD Opteron, an Intel ARM, an Intel XScale, a Transmeta Crusoe, a Transmeta Efficeon, an Intel Xenon, an Intel Itanium, or an Intel Pentium. Computer 5000 as shown in this example also includes a touch screen 5001 and a keyboard 5002. In various embodiments, a mouse, keypad, and/or interface might alternately or additionally be employed. Computer 5000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, the computer 5000 may be additionally equipped with internet protocol datacasting (IPDC) or time-sliced internet protocol datacasting (DVB-H) receiving means and devices. The computer may include (not shown) one or more decoders for decoding the datacasting singnals, such as video, audio and data streams, and one or more buffer memories for storing the decoded datacast signal before presentation or utilization of it.

Additionally, the computer 5000 may include (not shown) one or more location detection or satellite navigation systems devices and means, such as a global positioning system (GPS).

In accordance with various embodiments of the present invention, a computer may run one or more software modules designed to perform one or more of the above-described operations. Such modules might, for example, be programmed using languages such as Java, Objective C, C, C#, C++, Perl, and/or Xen according to methods known in the art. Corresponding program code might be placed on media such as, for example, DVD, CD-ROM, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed.

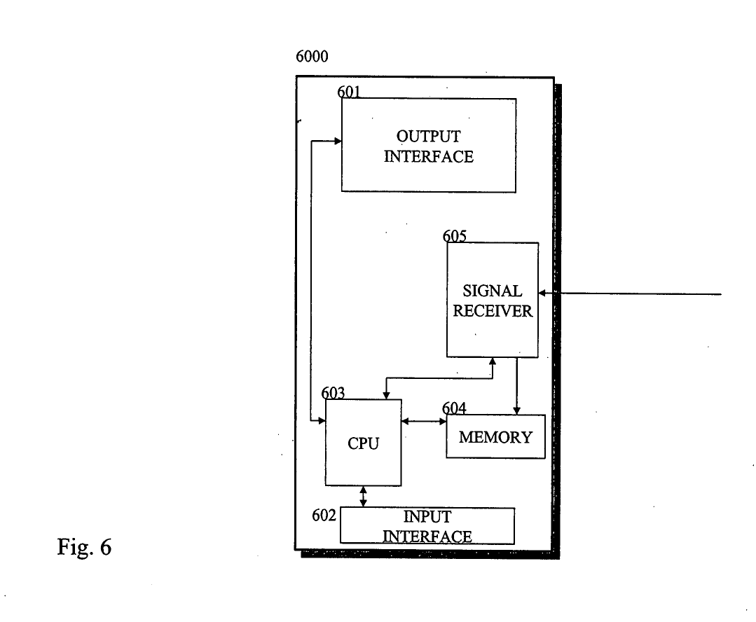

Shown in FIG. 6 is a block diagram of a terminal 6000, an exemplary computer employable in various embodiments of the present invention. The terminal 6000 may be implemented or connected to the computer 5000. In the following, corresponding reference signs are applied to corresponding parts. Exemplary terminal 6000 of FIG. 6 comprises a processing unit CPU 603, a signal receiver 605, and a user interface (601, 602). Signal receiver 605 may, for example, be a single-carrier or multi-carrier receiver. Signal receiver 605 and the user interface (601, 602) are coupled with the processing unit CPU 603. One or more direct memory access (DMA) channels may exist between signal receiver 605 and memory 604. The user interface (601, 602) comprises a display and a keyboard to enable a user to use the terminal 6000. In addition, the user interface (601, 602) comprises a microphone and a speaker for receiving and producing audio signals. The user interface (601, 602) may also comprise voice recognition (not shown).

The processing unit CPU 603 comprises a microprocessor (not shown), memory 604 and possibly software. The software can be stored in the memory 604. The microprocessor controls, on the basis of the software, the operation of the terminal 6000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 6, alternatively, middleware or software implementation can be applied. The terminal 6000 can, for instance, be a hand-held device which a user can comfortably carry. The terminal 6000 can, for example, be a cellular mobile phone or a portable or mobile TV which comprises signal receiver 605 for receiving the multicast transmission strearni. Therefore, the terminal 6000 may possibly interact with the service providers.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems and details of the invention that are described above in the application may be combined separately or in any combination to create or describe new embodiments of the invention.

1. A method comprising:
detecting a plurality of datacast signals;
receiving, for one or more of the detected signals, one or more service parameters;
informing a user of a plurality of service listings; and
presenting, in accordance with specification of the user, one or more of the service listings, wherein service listing data received using one or more of the service parameters is employed in presenting.

2. The method of claim 1, wherein one or more network information tables are received.

3. The method of claim 1, wherein one or more of the received service parameters are stored.

4. The method of claim 1, wherein one or more network information tables are stored.

5. The method of claim 1, wherein the user is presented with one or more selectable elements corresponding to the plurality of service listings.

6. The method of claim 5, wherein one or more service provider names are displayed with respect to one or more of the elements.

7. The method of claim 5, wherein one or more platform names are employed in implementing one or more of the elements.

8. The method of claim 5, wherein one or more platform identifiers are employed in implementing one or more of the elements.

9. The method of claim 5, wherein one or more icons are displayed.

10. The method of claim 1, further comprising receiving one or more programs.

11. The method of claim 10, wherein one or more video programs are received.

12. The method of claim 10, wherein one or more audio programs are received.

13. The method of claim 10, wherein one or more interactive programs are received.

14. The method of claim 1, wherein signals are scanned in a defined frequency range.

15. The method of claim 1, wherein one or more network information tables are interpreted.

16. The method of claim 1, wherein one or more platform identifiers correspond to at least some of the service listing data.

17. The method of claim 1, wherein one or more platform identifiers correspond to at least some of the service parameters used in receiving the service listing data.

18. The method of claim 1, wherein some or all of the service listing data is stored.

19. The method of claim 1, wherein at least some of the received service parameters are received via receipt of one or more network information tables.

20. The method of claim 1, wherein at least some of the received service parameters are received via internet protocol datacast.

21. The method of claim 1, wherein at least some of the received service parameters are received via universal mobile telecommunications service.

22. The method of claim 1, wherein at least some of the received service parameters are received via general packet radio service.

23. The method of claim 1, wherein at least some of the received service parameters are received via adjusting a tuner to a frequency.

24. The method of claim 1, wherein at least some of the received service parameters are received via associating a device with a multicast internet protocol address.

25. The method of claim 1, wherein at least some of the received service parameters are received via connection with an internet protocol address.

26. The method of claim 1, wherein receiving the service listing data involves receiving an internet protocol datacast data stream.

27. The method of claim 1, wherein receiving the service listing data involves adjusting a tuner to a frequency.

28. The method of claim 1, wherein receiving the service listing data involves associating a device with a multicast internet protocol address.

29. The method of claim 1, wherein receiving the service listing data involves receiving data from an internet protocol address.

30. The method of claim 1, wherein receiving the service listing data involves universal mobile telecommunications service.

31. The method of claim 1, wherein receiving the service listing data involves general packet radio service.

32. The method of claim 1, wherein the received service parameters include data regarding service providers.

33. The method of claim 1, wherein the received service parameters include data regarding network parameters.

34. The method of claim 1, wherein the received service parameters include data regarding platform parameters.

35. The method of claim 1, wherein the received service parameters include data regarding routing table parameters.

36. The method of claim 1, wherein the received service parameters include data regarding signal parameters.

37. The method of claim 1, wherein the received service parameters include one or more platform names.

38. The method of claim 1, wherein the received service parameters include one or more platform identifiers.

39. A method comprising:
detecting a plurality of datacast signals;
receiving, for each of a plurality of the detected signals, one or more service parameters; and
employing one or more of the service parameters in receiving service listing data.

40. The method of claim 39, wherein one or more network information tables are received.

41. The method of claim 39, wherein one or more of the received service parameters are stored.

42. The method of claim 39, wherein one or more network information tables are stored.

43. The method of claim 39, wherein a user is presented with one or more selectable elements corresponding to a plurality of service listings.

44. The method of claim 43, wherein one or more service provider names are displayed with respect to one or more of the elements.

45. The method of claim 43, wherein one or more platform names are employed in implementing one or more of the elements.

46. The method of claim 43, wherein one or more platform identifiers are employed in implementing one or more of the elements.

47. The method of claim 43, wherein one or more icons are displayed.

48. The method of claim 39, further comprising receiving one or more programs.

49. The method of claim 48, wherein one or more video programs are received.

50. The method of claim 48, wherein one or more audio programs are received.

51. The method of claim 48, wherein one or more interactive programs are received.

52. The method of claim 39, wherein signals are scanned in a defined frequency range.

53. The method of claim 39, wherein one or more network information tables are interpreted.

54. The method of claim 39, wherein one or more platform identifiers correspond to at least some of the service listing data.

55. The method of claim 39, wherein one or more platform identifiers correspond to at least some of the service parameters employed in receiving the service listing data.

56. The method of claim 39, wherein some or all of the service listing data is stored.

57. The method of claim 39, wherein at least some of the received service parameters are received via receipt of one or more network information tables.

58. The method of claim 39, wherein at least some of the received service parameters are received via internet protocol datacast.

59. The method of claim 39, wherein at least some of the received service parameters are received via universal mobile telecommunications service.

60. The method of claim 39, wherein at least some of the received service parameters are received via general packet radio service.

61. The method of claim 39, wherein at least some of the received service parameters are received via adjusting a tuner to a frequency.

62. The method of claim 39, wherein at least some of the received service parameters are received via associating a device with a multicast internet protocol address.

63. The method of claim 39, wherein at least some of the received service parameters are received via connection with an internet protocol address.

64. The method of claim 39, wherein receiving the service listing data involves receiving an internet protocol datacast data stream.

65. The method of claim 39, wherein receiving the service listing data involves adjusting a tuner to a frequency.

66. The method of claim 39, wherein receiving the service listing data involves associating a device with a multicast internet protocol address.

67. The method of claim 39, wherein receiving the service listing data involves receiving data from an internet protocol address.

68. The method of claim 39, wherein receiving the service listing data involves universal mobile telecommunications service.

69. The method of claim 39, wherein receiving the service listing data involves general packet radio service.

70. The method of claim 39, wherein the received service parameters include data regarding service providers.

71. The method of claim 39, wherein the received service parameters include data regarding network parameters.

72. The method of claim 39, wherein the received service parameters include data regarding platform parameters.

73. The method of claim 39, wherein the received service parameters include data regarding routing table parameters.

74. The method of claim 39, wherein the received service parameters include data regarding signal parameters.

75. The method of claim 39, wherein the received service parameters include one or more platform names.

76. The method of claim 39, wherein the received service parameters include one or more platform identifiers.

77. A system comprising:
a memory having program code stored therein; and
a processor disposed in communication with the memory for carrying out instructions in accordance with the stored program code;
wherein the program code, when executed by the processor, causes the processor to perform:
detecting a plurality of datacast signals;
receiving, for one or more of the detected signals, one or more service parameters;
informing a user of a plurality of service listings; and
presenting, in accordance with specification of the user, one or more of the service listings, wherein service listing data received using one or more of the service parameters is employed in presenting.

78. The system of claim 77, wherein one or more network information tables are received.

79. The system of claim 77, wherein one or more of the received service parameters are stored.

80. The system of claim 77, wherein one or more network information tables are stored.

81. The system of claim 77, wherein the user is presented with one or more selectable elements corresponding to the plurality of service listings.

82. The system of claim 81, wherein one or more service provider names are displayed with respect to one or more of the elements.

83. The system of claim 81, wherein one or more platform names are employed in implementing one or more of the elements.

84. The system of claim 81, wherein one or more platform identifiers are employed in implementing one or more of the elements.

85. The system of claim 81, wherein one or more icons are displayed.

86. The system of claim 77, wherein the processor further performs receiving one or more programs.

87. The system of claim 86, wherein one or more video programs are received.

88. The system of claim 86, wherein one or more audio programs are received.

89. The system of claim 86, wherein one or more interactive programs are received.

90. The system of claim 77, wherein signals are scanned in a defined frequency range.

91. The system of claim 77, wherein one or more network information tables are interpreted.

92. The system of claim 77, wherein one or more platform identifiers correspond to at least some of the service listing data.

93. The system of claim 77, wherein one or more platform identifiers correspond to at least some of the service parameters used in receiving the service listing data.

94. The system of claim 77, wherein some or all of the service listing data is stored.

95. The system of claim 77, wherein at least some of the received service parameters are received via receipt of one or more network information tables.

96. The system of claim 77, wherein at least some of the received service parameters are received via internet protocol datacast.

97. The system of claim 77, wherein at least some of the received service parameters are received via universal mobile telecommunications service.

98. The system of claim 77, wherein at least some of the received service parameters are received via general packet radio service.

99. The system of claim 77, wherein at least some of the received service parameters are received via adjusting a tuner to a frequency.

100. The system of claim 77, wherein at least some of the received service parameters are received via associating a device with a multicast internet protocol address.

101. The system of claim 77, wherein at least some of the received service parameters are received via connection with an internet protocol address.

102. The system of claim 77, wherein receiving the service listing data involves receiving an internet protocol datacast data stream.

103. The system of claim 77, wherein receiving the service listing data involves adjusting a tuner to a frequency.

104. The system of claim 77, wherein receiving the service listing data involves associating a device with a multicast internet protocol address.

105. The system of claim 77, wherein receiving the service listing data involves receiving data from an internet protocol address.

106. The system of claim 77, wherein receiving the service listing data involves universal mobile telecommunications service.

107. The system of claim 77, wherein receiving the service listing data involves general packet radio service.

108. The system of claim 77, wherein the received service parameters include data regarding service providers.

109. The system of claim 77, wherein the received service parameters include data regarding network parameters.

110. The system of claim 77, wherein the received service parameters include data regarding platform parameters.

111. The system of claim 77, wherein the received service parameters include data regarding routing table parameters.

112. The system of claim 77, wherein the received service parameters include data regarding signal parameters.

113. The system of claim 77, wherein the received service parameters include one or more platform names.

114. The system of claim 77, wherein the received service parameters include one or more platform identifiers.

115. A system comprising:
a memory having program code stored therein; and
a processor disposed in communication with the memory for carrying out instructions in accordance with the stored program code;
wherein the program code, when executed by the processor, causes the processor to perform:
detecting a plurality of datacast signals;
receiving, for each of a plurality of the detected signals, one or more service parameters; and
employing one or more of the service parameters in receiving service listing data.

116. The system of claim 115, wherein one or more network information tables are received.

117. The system of claim 115, wherein one or more of the received service parameters are stored.

118. The system of claim 115, wherein one or more network information tables are stored.

119. The system of claim 115, wherein a user is presented with one or more selectable elements corresponding to a plurality of service listings.

120. The system of claim 119, wherein one or more service provider names are displayed with respect to one or more of the elements.

121. The system of claim 119, wherein one or more platform names are employed in implementing one or more of the elements.

122. The system of claim 119, wherein one or more platform identifiers are employed in implementing one or more of the elements.

123. The system of claim 119, wherein one or more icons are displayed.

124. The system of claim 115, wherein the processor further performs receiving one or more programs.

125. The system of claim 124, wherein one or more video programs are received.

126. The system of claim 124, wherein one or more audio programs are received.

127. The system of claim 124, wherein one or more interactive programs are received.

128. The system of claim 115, wherein signals are scanned in a defined frequency range.

129. The system of claim 115, wherein one or more network information tables are interpreted.

130. The system of claim 115, wherein one or more platform identifiers correspond to at least some of the service listing data.

131. The system of claim 115, wherein one or more platform identifiers correspond to at least some of the service parameters employed in receiving the service listing data.

132. The system of claim 115, wherein some or all of the service listing data is stored.

133. The system of claim 115, wherein at least some of the received service parameters are received via receipt of one or more network information tables.

134. The system of claim 115, wherein at least some of the received service parameters are received via internet protocol datacast.

135. The system of claim 115, wherein at least some of the received service parameters are received via universal mobile telecommunications service.

136. The system of claim 115, wherein at least some of the received service parameters are received via general packet radio service.

137. The system of claim 115, wherein at least some of the received service parameters are received via adjusting a tuner to a frequency.

138. The system of claim 115, wherein at least some of the received service parameters are received via associating a device with a multicast internet protocol address.

139. The system of claim 115, wherein at least some of the received service parameters are received via connection with an internet protocol address.

140. The system of claim 115, wherein receiving the service listing data involves receiving an internet protocol datacast data stream.

141. The system of claim 115, wherein receiving the service listing data involves adjusting a tuner to a frequency.

142. The system of claim 115, wherein receiving the service listing data involves associating a device with a multicast internet protocol address.

143. The system of claim 115, wherein receiving the service listing data involves receiving data from an internet protocol address.

144. The system of claim 115, wherein receiving the service listing data involves universal mobile telecommunications service.

145. The system of claim 115, wherein receiving the service listing data involves general packet radio service.

146. The system of claim 115, wherein the received service parameters include data regarding service providers.

147. The system of claim 115, wherein the received service parameters include data regarding network parameters.

148. The system of claim 115, wherein the received service parameters include data regarding platform parameters.

149. The system of claim 115, wherein the received service parameters include data regarding routing table parameters.

150. The system of claim 115, wherein the received service parameters include data regarding signal parameters.

151. The system of claim 115, wherein the received service parameters include one or more platform names.

152. The system of claim 115, wherein the received service parameters include one or more platform identifiers.

153. A user device comprising:
a memory having program code stored therein; and
a processor disposed in communication with the memory for carrying out instructions in accordance with the stored program code;
a network connection;
a display;
a user interface;
wherein the program code, when executed by the processor, causes the processor to perform:
connecting over the network to a datacasting network;
scanning the datacasting network for datacast service providers;
detecting one or more datacast service providers;
storing service parameters associated with the detected datacast service providers in the memory;
displaying selectable indicators for the detected datacast service providers on the display;
receiving via the user interface a selection of at least one of the datacast service providers;
configuring the network connection, in accordance with the stored service parameters of the selected datacast service providers identified by the selection, to receive an electronic service guide for the selected datacast service providers.

154. The device of claim 153, wherein the user device is a mobile communication device implemented with or connected to a time-sliced internet protocol datacasting (IPDC/DVB-H) receiver device.

155. The device of claim 153, wherein the datacast network is a time-sliced internet protocol datacasting network (IPDC/DVB-H).
